(19) United States
(12) Patent Application Publication
(10) Pub. No.: US 2021/0046438 A1
(43) Pub. Date: Feb. 18, 2021

(54) Surfactant Compositions and Methods for Emulsifying Cannabinoid Extracts as a Nano-Emulsion Material

(71) Applicant: Steven Paul Hansen, Calgary (CA)

(72) Inventor: Steven Paul Hansen, Calgary (CA)

(21) Appl. No.: 16/542,079

(22) Filed: Aug. 15, 2019

(51) Int. Cl. B01F 17/00

(52) U.S. Cl. CPC B01F 17/0092; B01F 17/0028; B01F 17/0064

(57) ABSTRACT

An embodiment of a CBD Nano-Emulsion material and process comprises a formulation comprising at least a lecithin or mixed lecithin, one or more carrier oils, and a Vitamin E TPGS from a sunflower version and a soy version. Among either version, the versions may further comprise mixed tocopherols, and still further comprise at least one of; an LCT oil, an olive oil, and a coconut oil. Any one of the versions may further comprise at least one of; sodium benzoate, potassium sorbate, and sorbic acid; and even yet further comprise purified water. Some embodiments may comprise a Vitamin E acetate.

### TECHNICAL FIELD

This disclosure relates generally to surfactant compositions and methods to create a nano-emulsion for a cannabinoid extract so as to be miscible in water; thereby creating a product to be used as a component in the production of ingestible goods.

### BACKGROUND

Cannabis extracts, as an oil-based component, are generally not water soluble or miscible with water. There are currently technologies that exist that render cannabinoids water soluble, but such technologies alter the cannabinoid molecules by functionalizing with groups such as sugars or phosphate esters. Creating new and untested altered cannabinoid molecules is technology that may be of interest to other third parties, but the present disclosure is directed to maintaining cannabis in its native form. Water miscible cannabis can be created using natural cannabis extracts in conjunction with emulsifiers derived from natural sources and with GRAS ratings, and that is the strategy disclosed herein.

There are several ways in which to render cannabis extracts miscible with water. Broadly, those consist of low energy processes and high energy processes. Low energy processes require more emulsifiers and are typically not infinitely dilutable in water. High energy processes require a minimum quantity of emulsifiers, and when combined with the correct surfactant technology are infinitely dilutable. High energy processes include technologies such as sonication and high-pressure homogenization. Those technologies are well-known. The present disclosure of novel surfactant technology is designed to work in conjunction with these high energy emulsification processes.

The prior art does not provide surfactant formulations for water-miscible extracts having all of the following properties: 1. Infinitely dilutable in water, 2. Kinetically stable over long time periods, 3. GRAS surfactant technologies, 4. translucent concentrates, 5. Availability in soy and non-soy versions (GMO free and non-GMO), 6. Temperature stable from about 0° C. to about 85° C., 7. Suitable for use with any high energy emulsification process, 8. Stable storage in both plastic and glass containers when diluted or not diluted, 9. Stable over a pH range from about 1 to about 13, 10. Compatible with a variety of products and cannabinoid delivery systems, including gummies (both gelatin and agar/pectin), transdermal patches, beverages (encompassing fruit juices with natural and artificial flavors, water, energy drinks and sport recovery drinks), foods (jello, baked goods), 11. Workable in ratios from about 5:1 surfactant:active ingredient to about 2:1 surfactant:active ingredient, 12. Compatible with a wide variety of carrier oils, including MCT, olive, grapeseed, coconut, LCT, almond, apricot kernel, avocado, canola, hemp, castor, jojoba, palm kernel, rosehip seed, borage seed, camellia seed, cranberry seed, hazelnut, macadamia nut, peanut, pomegranate, sesame, sunflower, watermelon seed, and the like, and 13. Tasteless (G2 embodiment) and odorless.

### SUMMARY

This disclosure teaches a cannabinoid nano-emulsion material comprising at least one formulation selected from a G1 family; wherein any such version comprises at least a lecithin, a carrier oil, such as MCT oil, and a polysorbate, such as polysorbate 20; a single component sunflower version, a single component soy version, a two-component sunflower version Part A and Part B, and a two-component soy version Part A and Part B. Among the G1 family versions, a polysorbate-20 may be replaced by one or more of; a polysorbate 40, a polysorbate 60, and a polysorbate 80. Any of the G1 family versions may further comprise at least one of; an LCT oil, an olive oil, and a coconut oil; and any of the single component family versions may further comprise at least one of; a yellow beeswax, sodium benzoate, potassium sorbate, sorbic acid, and vitamin E acetate. The G1 family versions may further comprise purified water.

This disclosure teaches a cannabinoid nano-emulsion material comprising at least one formulation selected from a G2 family, wherein any such family version comprises at least a lecithin, a carrier oil such as MCT oil, and a Vitamin E TPGS from a sunflower version and a soy version. Among the G2 family versions, the G2 family versions may further comprise mixed tocopherols, and still further comprise at least one of; an LCT oil, an olive oil, and a coconut oil. Any one of the G2 family versions may further comprise at least one of; sodium benzoate, potassium sorbate, and sorbic acid; and even yet further comprise purified water.

### DETAILED DESCRIPTION

Exemplary embodiments described herein may be described in terms of functional block components and various processing steps. Such functional blocks may be realized by any number of raw materials, hardware and/or even software components configured to perform the specified functions and to achieve various results. For example, surfactant compositions and methods for emulsifying cannabinoid extracts as a nano-emulsion material may employ various hardware components, e.g., various hardware equipment generally known in the chemical processing arts to process the various formulas, as well as for storage, packaging, distribution equipment and the like, which may carry out a variety of functions. In addition, surfactant compositions and methods for emulsifying cannabinoid extracts as a nano-emulsion material may be practiced in conjunction with any number of settings, such as for consumer use, commercial use, research, further development of associative materials and the like. Also, any processes, materials, systems and/or methods described are merely exemplary applications for the surfactant compositions and methods for emulsifying cannabinoid extracts as a nano-emulsion material, and the surfactant compositions and methods for emulsifying cannabinoid extracts as a nano-emulsion material may employ any number of conventional techniques for manufacturing, distributing, marketing, packaging, shipping, and the like.

What is disclosed herein are several novel families of surfactants, and these surfactants can effectively surround any cannabinoid, terpene, essential oil, hemp oil, or cannabis extract; and create a stable translucent nano-emulsion with particle sizes in the range of about 10 nm to about 70 nm and concentrations up to about 70 mg/mL. The following formulations and processes may apply to all families of cannabinoids, e.g. CBD, THC, THCV, CBN and the like. Moreover, the following formulations and processes may apply to various limonenes, pinenes, beta caryophyllenes, and the like.

### Surfactant Type

The surfactant families comprise:

G1—this contains polysorbate 20, which is suitable for concentrations up to about 20 mg/mL, and A-B, a two-component surfactant consisting of the oily lecithin part and the hydrophilic polysorbate 20 in roughly equal proportions; discussed in greater detail below.

G2—the function of polysorbate 20 is replaced by Vitamin E TPGS, aka Tocopherols. Similar to polysorbate 20, Vitamin E TPGS is synthetic, but it operates as a source of vitamin E. In a non-synthetic embodiment, part or all of the Vitamin E TPGS may be replaced with mixed tocopherols. Mixed tocopherols consist of 4 different vitamin E isomers, and have not been chemically modified.

G1 and G2 families are further broken down into those that contain soy-derived ingredients and those that contain sunflower-derived ingredients. Both lecithin and Vitamin E TPGS may be derived from soy or sunflower sources. Sunflower sources are considered to be preferred in most formulations, as many users are allergic to soy. Soy is also GMO (Genetically Modified Organism), whereas sunflower is not.

### Terms.

Carrier oil. A carrier oil operates to dissolve surfactant ingredients as well as the active ingredients. It lowers the viscosity of the surfactant/active melt to allow easy blending with water.

Emulsifier. An emulsifier (oil in water) operates to render a material that is otherwise insoluble in water miscible with water.

HLB. Hydrophilic-Lipophilic Balance. This is a numeric measure of the water solubility of the molecule.

Microemulsion. Microemulsions of the type disclosed herein comprise particle sizes in the range from about 200 nm to about 2 microns.

Nano-emulsion. Nano-emulsions of the type processed as described herein comprise particle sizes in the range from about 10 nm to about 70 nm.

Various representative embodiments may be applied to any method or system to surround any cannabinoid, terpene, essential oil, hemp oil or cannabis extract. Nano-emulsion materials and processes are as follows:

Ingredients

Carrier oils

MCT oil, aka medium chain triglyceride oil, is derived primarily from coconut sources. It is composed of C6 to C12 triglycerides. It is a healthy oil readily absorbed by the body and requires limited low energy to digest. It is an excellent solvent for lecithin and vitamin E TPGS, and an excellent carrier oil for cannabinoids and terpenes.

Coconut oil is composed of C8 to C18 triglycerides, with C12 being the most prominent. The coconut oil operates as a superior solvent for lecithin and vitamin E TPGS and a superior carrier oil for cannabinoids and terpenes.

LCT long chain triglycerides consist of C18 and higher triglycerides, and preferably glyceryl monolinoeate is used. LCT's increase bioavailability, although they are not great solvents or carrier oils. Other LCT's are available and those skilled in the art would employ such others.

Olive Oil. Olive oil consists primarily of oleic acid (C18) esters. It is thus rich in LCT oil, which is more bioavailable than MCT oil and less expensive than pure LCT oil.

Other carrier oils. Like those listed above are generally complex mixtures of triglycerides. They generally work best in combination with the four carrier oils listed above, but may operate with other carrier oils as well.

Emulsifiers

Lecithin. There are many grades of lecithin, most of which are unsuitable for use owing to high impurity content. The most suitable grades for use are those in which 100% of the constituents are soluble in ethanol. Lecithin may be derived from many sources, soy and sunflower being among the most common. It consists of choline, linoleic acid, linolenic acid and the phosphatides phosphatidylcholine, phosphatidylethanolamine, phosphatidylinositol, phosphatidic acid, and various vitamins and minerals. Higher grades contain more phosphatidyl choline. Lecithin acts as a low HLB emulsifier.

Vitamin E TPGS is a synthetic emulsifier made up of vitamin E, succinic acid and polyethylene glycol. Vitamin E can be isolated from soy or sunflower sources. It is not bitter, and combined with lecithin and the correct carrier oils makes an emulsifier that contributes a minimum of flavor. Along with being an excellent emulsifier it is a source of vitamin E and serves as an antioxidant. Vitamin E TPGS is a high HLB emulsifier.

Polysorbate 20 is a synthetic emulsifier made of ethoxylated sorbitan reacted with lauric acid. It is part of the Tween family of emulsifiers. It is very bitter but inexpensive relative to vitamin E TPGS. Polysorbate 20 is a high HLB emulsifier. Although Polysorbate 20 is the preferred synthetic emulsifier disclosed herein, those skilled in the art will appreciate that other Polysorbates may be employed, such as Polysorbate 40, Polysorbate 60, and/or Polysorbate 80.

Preservatives and Antioxidants

Sodium Benzoate is a water-phase preservative having bacteriostatic and fungistatic properties.

Potassium Sorbate is a water-phase preservative having bacteriostatic and fungistatic properties.

Sorbic Acid is an oil phase preservative having bacteriostatic and fungistatic properties.

Benzyl Alcohol acts in both oil and water phases and has bacteriostatic and fungistatic properties.

Vitamin E TPGS is an antioxidant. It operates as an oxygen scavenger and inhibits the THC to CBN reaction.

Vitamin E acetate is an antioxidant. It operates as a good oxygen scavenger and inhibits the THC to CBN reaction.

Mixed tocopherols are antioxidants. It operates as a good oxygen scavenger and inhibit the THC to CBN reaction.

Compatibilizer

Yellow beeswax allows the fatty carrier oils and lecithin to blend with polysorbate without the mixture separating.

Mixed tocopherols allow fatty carrier oils and lecithin to blend with Vitamin

E TPGS without the mixture separating.

Freeze/Thaw Stability

Glycerin may be added to increase freeze/thaw stability where required.

Processing

All formulations contain lecithin. Lecithin has a very high melting point and must be dissolved into a carrier oil. In an embodiment, a process uses a “chocolate conditioner” that allows for the oil and lecithin to be mixed together at elevated temperatures; from about 50° C. to about 85° C. A chocolate temperer may also be suitable for this purpose. The disclosed equipment significantly reduces dissolution time from 3 days to about 1 day or even less. It will further be appreciated by those skilled in the art that while such chocolate conditioners and/or temperers are preferably employed, other systems that can effectively accomplish the above with similar results may be used. For example, single or multishift mixers with heated bowls, and the like may be employed.

Those skilled in the art will appreciate that Vitamin E TPGS is a waxy solid. In formulations that comprise this ingredient, it is added to the chocolate conditioner and melted into the formulation. Sorbic acid is also dissolved into the warm melt.

Preservatives, including sodium benzoate and potassium sorbate, may be added as a solution in water or as a concentrated blend in a carrier oil or a carrier oil/lecithin blend.

G1 Family

In the single component G1 version, yellow beeswax is added to the melt. Polysorbate 20 and water-soluble preservatives are premixed using, preferably, an overhead mixer. The mixture is then added to the chocolate conditioner and blended with the lecithin, oils and sorbic acid.

In the two component G1 version (A-B), the polysorbate component is kept separate from the material in the chocolate conditioner. Beeswax is not needed in this formulation. To make an emulsifier, component A (lecithin/oil) is mixed with component B (polysorbate) at the time the emulsification is carried out.

G2 Family.

As with Gl, lecithin is dissolved in the chocolate conditioner along with sorbic acid. Vitamin E TPGS and/or tocopherols or tocotrienols is added and melted into the material once the lecithin has dissolved. Once homogenous the mixture is emptied into a food grade mixing container where upon sodium benzoate and potassium sorbate are added as aqueous solutions with overhead mixing. The resulting product is dispensed while it is at about 40° C. to about 45° C. to avoid solidification; the mixture is moved out of the chocolate mixing machine between about 50° C. to about 65° C.

Formulas

G1 Single Component. Soy version.

| | Weight Percentage |
|---|---|
| Ingredient | Range |
| Single or mixed | 20-95 |
| Lecithins | |
| MCT oil | 10-50 |
| Polysorbate 20 | 10-50 |
| Olive oil | 0-20 |
| LCT oil | 0-20 |
| Coconut oil | 0-20 |
| Purified water | 0-10 |
| Yellow Beeswax | 0-2 |
| Sodium Benzoate | 0-2 |
| Potassium Sorbate | 0-2 |
| Sorbic Acid | 0-2 |
| Vitamin E Acetate | 0-2 |

G1 Single Component. Sunflower version.

| | Weight Percentage |
|---|---|
| Ingredient | Range |
| Single or mixed | 20-95 |
| Lecithins | |
| MCT oil | 10-50 |
| Polysorbate 20 | 10-50 |
| Olive oil | 0-20 |
| LCT oil | 0-20 |
| Coconut oil | 0-20 |
| Purified water | 0-10 |
| Yellow Beeswax | 0-2 |
| Sodium Benzoate | 0-2 |
| Potassium Sorbate | 0-2 |
| Sorbic Acid | 0-2 |
| Vitamin E Acetate | 0-2 |

G1 Two Component. Soy version. Part A

| | Weight Percentage |
|---|---|
| Ingredient | Range |
| Single or mixed | 20-95 |
| Lecithins | |
| MCT oil | 20-80 |
| Olive oil | 0-20 |
| LCT oil | 0-20 |
| Coconut oil | 0-20 |
| Sorbic Acid | 0-5 |
| Vitamin E Acetate | 0-5 |

G1 Two Component. Sunflower version. Part A

| | Weight Percentage |
|---|---|
| Ingredient | Range |
| Single or mixed | 20-95 |
| Lecithins | |
| MCT oil | 20-80 |
| Olive oil | 0-20 |
| LCT oil | 0-20 |
| Coconut oil | 0-20 |
| Sorbic Acid | 0-5 |
| Vitamin E Acetate | 0-5 |

G1 Two Component. Part B
(For Either Soy or Sunflower version Part A)

| | Weight Percentage |
|---|---|
| Ingredient | Range |
| Polysorbate 20 | 50-100 |
| Purified water | 0-10 |
| Sodium Benzoate | 0-5 |
| Potassium Sorbate | 0-5 |

G2 Soy version

| | Weight Percentage |
|---|---|
| Ingredient | Range |
| MCT oil | 10-50 |
| Vitamin E TPGS | 10-50 |
| Single or mixed | 20-95 |
| Lecithins | |
| Olive oil | 0-20 |
| Mixed tocopherols | 0-20 |
| LCT oil | 0-20 |
| Coconut oil | 0-20 |
| Purified water | 0-10 |
| Sodium Benzoate | 0-2 |
| Potassium Sorbate | 0-2 |
| Sorbic Acid | 0-2 |

G2 Sunflower version

| Ingredient | Range |
|---|---|
| MCT oil | 10-50 |
| Vitamin E TPGS | 10-50 |
| Single or mixed | 20-95 |
| Lecithins | |
| Olive oil | 0-20 |
| Mixed tocopherols | 0-40 |
| LCT oil | 0-20 |
| Coconut oil | 0-20 |
| Purified water | 0-10 |
| Sodium Benzoate | 0-2 |
| Potassium Sorbate | 0-2 |
| Sorbic Acid | 0-2 |

### Emulsifying and Post Processing

In a representative embodiment, surfactant is combined with active ingredient at a ratio of about 5 parts surfactants to about 1-part cannabinoid extract. Depending on the nature of the active ingredient, the ratio can go as low as 3:1. The mixture is melted together with mixing at a temperature from about 50° C. to about 70° C. When the mixture is homogenous, heat is removed, water is added such that that the total percentage of cannabinoid is between about 1% and about 7%. Concentrations of about 2% to about 3% (about 20 to about 30 mg/mL) are preferred, as those concentrations tend to give the smallest particle sizes and the tightest particle size distribution as measured by DLS techniques. The mixture is stirred with a stir bar or overhead mixer until the material is homogenous; about 10 to about 15 minutes. When homogenous, the subsequent mixture is considered a microemulsion, and comprises a mixture that is essentially opaque and comprises a white or beige coloration depending on the type of cannabinoid extract used. Once the microemulsion is formed it may be sonicated or put through a high-pressure homogenizer. Depending on the probe and power level, sonication times range from about 3 to about 30 minutes. Homogenization time is dependent on pressure and the internal geometry and configuration of the intensifier chamber. Those skilled in the art will appreciate that any sonication and/or homogenization processes known in the art may be employed and such process equipment may comprise from 1 to about 15 passes via such equipment so as to achieve particle sizes from about 10 nm to about 70 nm.

Among various embodiments, once the surfactant and active ingredient are completely homogenous, water is added with stirring, which creates a microemulsion. After stirring, preferably with a stir bar or overhead mixer, for approximately 10 minutes, the material may then be put through a high-pressure homogenizer or sonicated. In principal, any technique that imparts a large amount of mechanical energy into the microemulsion may produce a nano-emulsion.

Among various embodiments, after emulsification, the nano-emulsion may be put through a 220 nm filter to remove insoluble impurities and any microorganisms that may be present. The product is then sealed in a sterile bottle or other suitable storage container and refrigerated.

In an embodiment, if freeze/thaw stability is required, glycerin may be added at levels of up to about 20%.

In the foregoing specification, surfactant compositions and methods for emulsifying cannabinoid extracts as a nano-emulsion material have been described with reference to specific exemplary embodiments. Various modifications and changes may be made, however, without departing from the scope of surfactant compositions and methods for emulsifying cannabinoid extracts as a nano-emulsion material as set forth in the claims. The detailed description is illustrative of representative embodiments, rather than restrictive, and modifications are intended to be included within the scope of the various representative embodiments. Accordingly, the scope of the representative embodiments should be determined by the claims and their legal equivalents, rather than by merely the examples described.

For example, the steps recited in any method or process claims may be executed in various orders to achieve the desired results and are may not limited to the specific order presented in the claims. Additionally, the components and/or elements recited in any article, material, system, apparatus and/or device claims may be assembled or otherwise operationally configured in a variety of permutations and are accordingly may not be limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required, or essential features or components of any or all the claims.

As used herein, the terms “comprise”, “comprises”, “comprising”, “having”, “including”, “includes” “is” or any variation thereof, are intended to reference a non-exclusive inclusion, such that a process, method, article, system, device, material, composition or apparatus that comprises a list of elements does not include only those elements recited, but may also include other elements not expressly listed or inherent to such process, method, article, system, device, material, composition or apparatus. Other combinations and/or modifications of the above-described structures, arrangements, applications, proportions, elements, materials or components used in the practice of the surfactant compositions and methods for emulsifying cannabinoid extracts as a nano-emulsion material, in addition to those not specifically recited, may be varied or otherwise particularly adapted to specific environments, manufacturing specifications, design parameters or other operating requirements without departing from the general principles of the same.

As used herein, the terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of surfactant compositions and methods for emulsifying cannabinoid extracts as a nano-emulsion material described herein are, for example, capable of operation in sequences other than those illustrated or otherwise described herein.

What is claimed is:

1. A cannabinoid nano-emulsion material comprises at least one formulation selected from a G1 family, wherein any such family version comprises at least a lecithin, a carrier oil and a polysorbate from;
a single component sunflower version, a single component soy version, a two-component sunflower version Part A and Part B, and a two-component soy version Part A and Part B.

2. The material of claim 1, wherein a polysorbate-20 may be replaced by one of; a polysorbate 40, a polysorbate 60, and a polysorbate 80.

3. The material of claim 2 further comprising at least one of; an LCT oil, an olive oil, and a coconut oil.

4. The material of claim 3, wherein any of the single component versions may further comprise at least one of; a yellow beeswax, sodium benzoate, potassium sorbate, sorbic acid, and vitamin E acetate.

5. The material of claim 4, wherein any of the versions may further comprise purified water.

6. A cannabinoid nano-emulsion material comprises at least one formulation selected from a G2 family, wherein any such family version comprises at least a lecithin, a carrier oil, and a Vitamin E TPGS from a sunflower version and a soy version.

7. The material of claim 6 further comprising mixed tocopherols.

8. The material of claim 7 further comprising at least one of; an LCT oil, an olive oil, and a coconut oil.

9. The material of claim 8, wherein any of the versions may further comprise at least one of; sodium benzoate, potassium sorbate, and sorbic acid.

10. The material of claim 9, wherein any of the versions may further comprise purified water.
